(19) United States
(12) Patent Application Publication
(10) Pub. No.: US 2025/0357830 A1
(43) Pub. Date: Nov. 20, 2025

(54) METHOD FOR MANUFACTURING MOTOR CORE

(71) Applicant: TOYOTA BOSHOKU KABUSHIKI KAISHA, Aichi-ken (JP)

(72) Inventors: Ryota SASAKI, Toyota-shi (JP); Harutaka ODA, Toyota-shi (JP)

(73) Assignee: TOYOTA BOSHOKU KABUSHIKI KAISHA, Aichi-ken (JP)

(21) Appl. No.: 19/194,880

(22) Filed: Apr. 30, 2025

(30) Foreign Application Priority Data
May 17, 2024 (JP) 2024-080997

(51) Int. Cl. H02K 15/027

(52) U.S. Cl. CPC H02K 15/027

(57) ABSTRACT

A method for manufacturing a motor core includes forming multiple blocks and forming the motor core. When a first separator plate is stacked on iron core pieces, a tab of the first separator plate is aligned with tabs of the iron core pieces. When a second separator plate is stacked on the first separator plate, a tab of the second separator plate is aligned with a through-hole of the first separator plate. When the iron core pieces are stacked on the second separator plate, the tabs are aligned with the tab of the second separator plate. The forming the motor core includes: stacking the blocks such that the tab of the first separator plate of one of any two blocks adjacent to each other and the tab of the second separator plate of the other block overlap with each other; and in this state, joining the blocks together.

### CROSS-REFERENCE TO RELATED APPLICATIONS

This application is based upon and claims the benefit of priority from Japanese Patent Application No. 2024-080997, filed on May 17, 2024, the entire contents of which are incorporated herein by reference.

### BACKGROUND

### 1. Field

The present disclosure relates to a method for manufacturing a motor core.

### 2. Description of Related Art

Motor cores, such as rotor cores and stator cores used in motors, are formed by a method for manufacturing a motor core that includes a block forming step and a core forming step.

In the block forming step, as disclosed in, for example, Japanese Laid-Open Patent Publication No. 2020-58097, a block is formed by punching iron core pieces having tabs from a thin plate-shaped material and then stacking the iron core pieces such that the tabs overlap with each other. When the block is formed in this way, the overlapping tabs of the iron core pieces are press-fitted to each other, so that the iron core pieces are joined to each other.

In addition, in the block forming step, after every several repetitions of stacking the iron core pieces, a separator plate having through-holes is punched from the material and stacked onto the stacked iron core pieces. The through-holes in the separator plate are positioned to correspond to the tabs of the iron core pieces. Accordingly, the separator plate is disposed in the lowermost layer of the stacked iron core pieces in the block formed in the block forming step. The separator plate prevents blocks adjacent to each other from being joined to each other through press-fitting of tabs.

The blocks formed in the block forming step are stacked in the direction in which a center line extends to a quantity required for motor core formation, in a configuration suitable for transport. The stacked blocks are then transported to a pressing device for a pressing process. In the pressing device, the blocks are pressed in the direction in which the center line extends so as to be compressed. The pressing process is intended to further strengthen the joining by press-fitting the overlapping tabs of the iron core pieces in the block to each other.

After the pressing process is performed, the core forming step is performed. In the core forming step, a motor core is formed by welding the blocks, which have undergone the pressing process, together.

In the above-described motor core manufacturing method, since the motor core is formed by welding the blocks to each other in the core forming step, welding equipment and welding operations are required. Further, as the joining area between the iron core pieces increases due to welding between the blocks, eddy currents generated in the motor increase, which leads to a reduction in motor performance.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for manufacturing a motor core includes forming multiple blocks by punching iron core pieces each having a tab from a thin plate-shaped material and stacking the iron core pieces such that the tabs overlap with each other, and forming the motor core by stacking the blocks and joining the blocks to each other. The forming the blocks includes, every time the iron core pieces are stacked multiple times, arranging a first separator plate and a second separator plate at opposite ends in a stacking direction of the iron core pieces of each block by punching the first separator plate having a tab and a through-hole from the material and stacking the first separator plate on the iron core pieces, and punching the second separator plate having a tab and a through-hole from the material and stacking the second separator plate on the first separator plate. When the first separator plate is stacked on the iron core pieces, the tab of the first separator plate is aligned with the tabs of the iron core pieces. When the second separator plate is stacked on the first separator plate, the tab of the second separator plate is aligned with the through-hole of the first separator plate. When the iron core pieces are stacked on the second separator plate after the second separator plate is stacked on the first separator plate, the tabs of the iron core pieces are aligned with the tab of the second separator plate. The forming the motor core includes stacking the blocks while rotating the blocks relative to each other such that the tab of the first separator plate of one of any two blocks adjacent to each other in the stacking direction of the blocks and the tab of the second separator plate of the other of the two blocks overlap with each other, and, in this state, joining the blocks together by press-fitting the tabs to each other.

Other features and aspects will be apparent from the following detailed description, the drawings, and the claims.

### BRIEF DESCRIPTION OF THE DRAWINGS

FIG. 1 is a front view of a stator core as a motor core.

FIG. 2 is a cross-sectional view of the stator core as viewed in a direction of arrows II-II in FIG. 1.

FIG. 3 is a plan view of an iron core piece forming a block of the stator core shown in FIG. 2.

FIG. 4 is a plan view showing a first separator plate forming the block of the stator core shown in FIG. 2.

FIG. 5 is a plan view showing a second separator plate forming the block of the stator core shown in FIG. 2.

FIG. 6 is a cross-sectional view of a progressive press device for forming the block shown in FIG. 2.

FIG. 7 is a cross-sectional view showing a stacked state of blocks formed by the progressive press device shown in FIG. 6.

FIG. 8 is a plan view of the first separator plate.

FIG. 9 is a plan view of the second separator plate.

FIG. 10 is a plan view showing a positional relationship between the first separator plate and the second separator plate shown in FIGS. 8 and 9.

FIG. 11 is a plan view showing a positional relationship between the first separator plate and the second separator plate shown in FIGS. 8 and 9.

FIG. 12 is a plan view of a first separator plate according to a modification.

FIG. 13 is a plan view of a second separator plate according to the modification.

FIG. 14 is a plan view showing a positional relationship between the first separator plate and the second separator plate shown in FIGS. 12 and 13.

FIG. 15 is a plan view showing a positional relationship between the first separator plate and the second separator plate shown in FIGS. 12 and 13.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

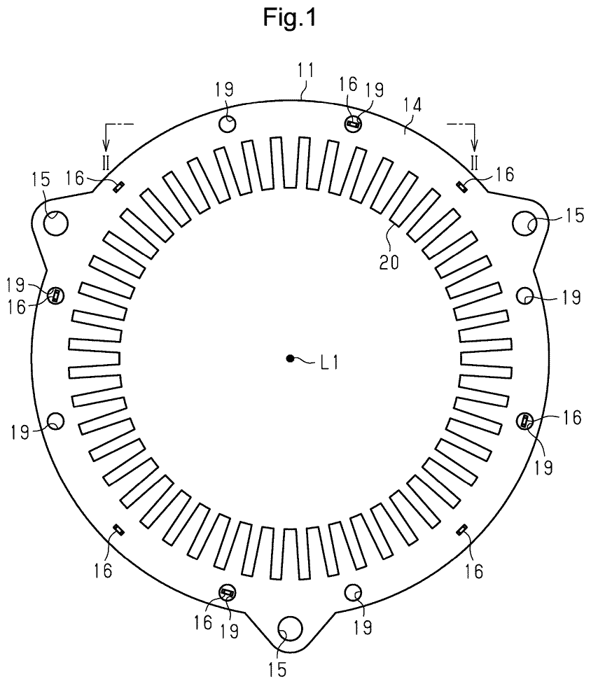

A method for manufacturing a motor core, such as a stator core in a motor, according to a first embodiment will now be described with reference to FIGS. 1 to 7.

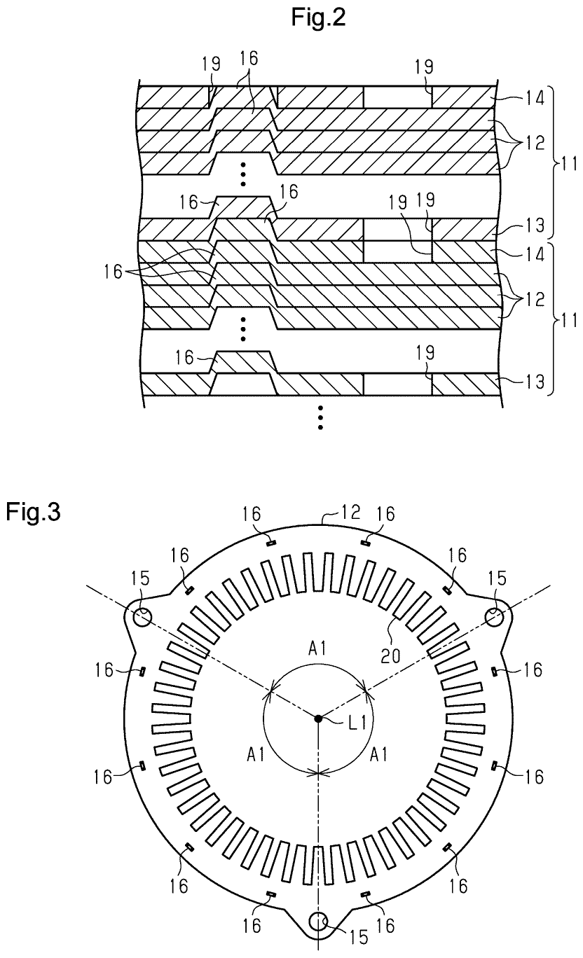

FIG. 1 shows a stator core as viewed in a direction in which a center line L1 of the stator core extends. FIG. 2 shows a state of the stator core as viewed in the direction of arrows II-II in FIG. 1. As can be seen from FIG. 2, the stator core is formed by stacking multiple blocks 11 in the direction in which the center line L1 extends. Each block 11 includes iron core pieces 12, a first separator plate 13, and a second separator plate 14. The iron core pieces 12, the first separator plates 13, and the second separator plates 14 are formed by being punched from a thin plate-shaped material.

Each block 11 is formed by stacking iron core pieces 12, a first separator plate 13, and a second separator plate 14 in the direction in which the center line L1 extends. In the block 11, a large number of iron core pieces 12 are stacked in the direction in which the center line L1 extends. The first separator plate 13 and the second separator plate 14 are disposed at the opposite ends of each block 11 in the stacking direction of the iron core pieces 12. The first separator plate 13 is located at the lowermost layer of each block 11 in FIG. 2. The second separator plate 14 is located at the uppermost layer in each block 11 of FIG. 2.

### Iron Core Pieces 12

As shown in FIG. 3, each iron core piece 12 has an annular plate shape having a center hole 20. Multiple mounting holes 15 are formed at the outer edge of the iron core piece 12 at equal angular intervals around the center line L1. The mounting holes 15 are for fixing the stator core to the case of the motor with bolts or the like. In this example, three mounting holes 15 are formed in the iron core piece 12 at angular intervals of 120°.

Each iron core piece 12 has multiple tabs 16 on a circumference around the center line L1. The iron core pieces 12 in the block 11 are joined to each other by press-fitting the tabs 16 to each other. The tabs 16 are located at angular intervals of 30° around the center line L1. Therefore, the number of the tabs 16 in each iron core piece 12 is twelve. In addition, when the iron core piece 12 is divided into an odd number of regions A1 around the center line L1, more specifically, multiple regions A1 each having an angle of 120°, four tabs 16 are located in each region A1.

### First Separator Plate 13

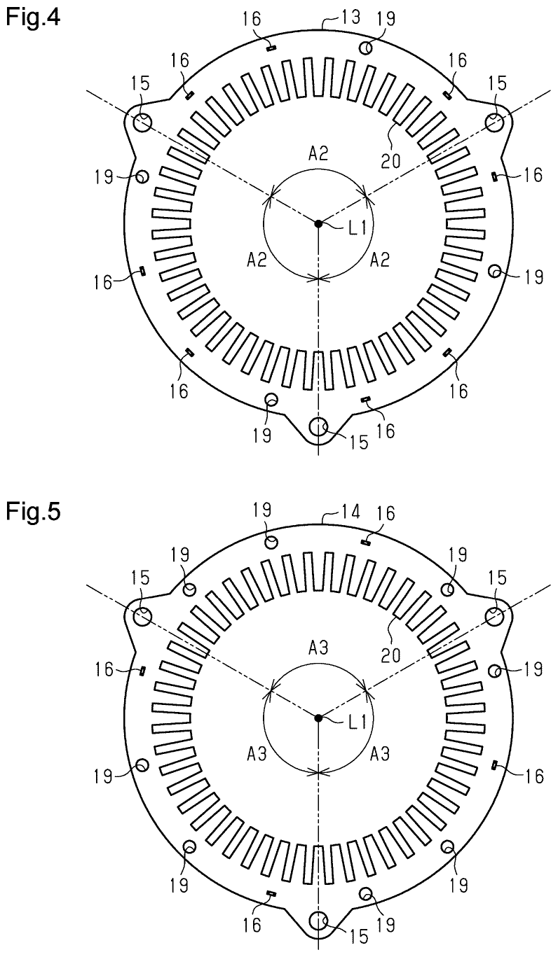

As shown in FIG. 4, the first separator plate 13 is an annular plate having a center hole 20, similarly to the iron core piece 12. Similar to the iron core piece 12, multiple mounting holes 15 are formed at the outer edge of the first separator plate 13 at equal angular intervals around the center line L1. These mounting holes 15 serve the same function as those in the iron core piece 12. The first separator plate 13 includes three mounting holes 15 at angular intervals of 120°.

On a circumference around the center line L1 of the first separator plate 13, multiple tabs 16 having the same shape as the tabs 16 of the iron core pieces 12 are formed, and multiple through-holes 19 are formed. The tabs 16 and the through-holes 19 are located at angular intervals of 30° around the center line L1. FIG. 4 shows the first separator plate 13 divided into an odd number of regions around the center line L1, more specifically, multiple regions A2 each having an angle of 120°. FIG. 4 illustrates the positional relationship between the tabs 16 and the through-holes 19 in the regions A2. As shown in FIG. 4, the through-holes 19 of the first separator plate 13 are formed every 90° around the center line L1. In the first separator plate 13, two tabs 16 are formed between adjacent through-holes 19. These tabs 16 are located at equal intervals from each other and from the through-holes 19.

### Second Separator Plate 14

As shown in FIG. 5, the second separator plate 14 is an annular plate having a center hole 20, similar to the iron core piece 12 and the first separator plate 13. Similar to the iron core piece 12 and the first separator plate 13, multiple mounting holes 15 are formed at the outer edge of the second separator plate 14 at equal angular intervals around the center line L1. These mounting holes 15 serve the same function as those in the iron core piece 12 and the first separator plate 13. The second separator plate 14 includes three mounting holes 15 at angular intervals of 120°.

On a circumference around the center line L1 of the second separator plate 14, multiple tabs 16 having the same shape as the tabs 16 of the iron core pieces 12 and the first separator plate 13 are formed, and multiple through-holes 19 having the same shape as the through-holes 19 of the first separator plate 13 are formed. The tabs 16 and the through-holes 19 are located at angular intervals of 30° around the center line L1. FIG. 5 shows the second separator plate 14 divided into an odd number of regions around the center line L1, more specifically, multiple regions A3 each having an angle of 120°. FIG. 5 illustrates the positional relationship between the tabs 16 and the through-holes 19 in the regions A3. As shown in FIG. 5, the tabs 16 of the second separator plate 14 are formed every 90° around the center line L1. In the second separator plate 14, two through-holes 19 are formed between adjacent tabs 16. These through-holes 19 are located at equal intervals from each other and from the tabs 16.

When the first separator plate 13 shown in FIG. 4 and the second separator plate 14 shown in FIG. 5 are stacked in the thickness direction, the positional relationship between the tabs 16 and the through-holes 19 is reversed in the regions A2 and A3 that overlap with each other in the thickness direction.

Next, a progressive press device for forming the block 11 will be described.

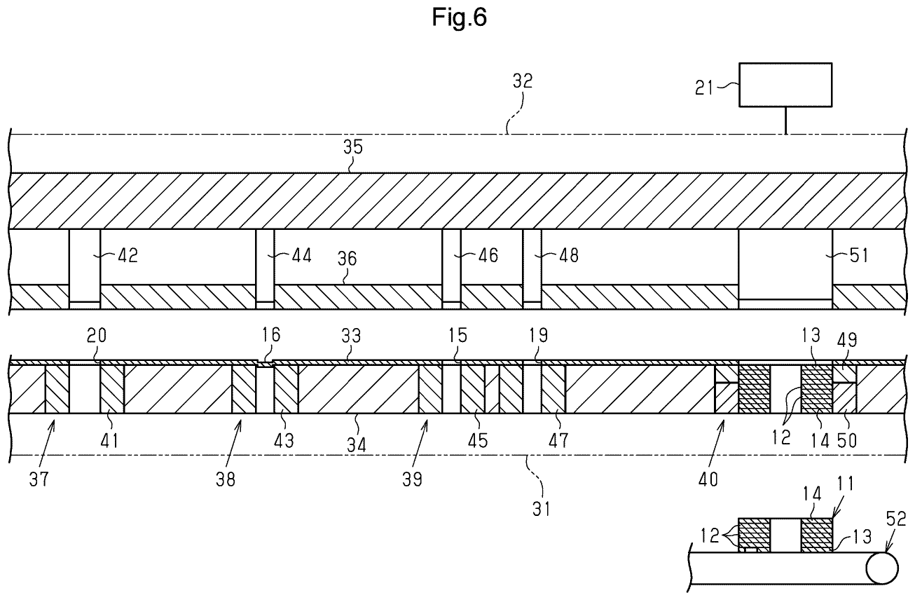

As shown in FIG. 6, the progressive press device repeats a die-closing operation, in which a slide 32 located above a bolster 31 approaches the bolster 31, and a die-opening operation, in which the slide 32 moves away from the bolster 31. A thin plate-shaped material 33 is conveyed between the bolster 31 and the slide 32. The material 33 is conveyed rightward in FIG. 6 by a predetermined feed pitch during each die-opening operation of the progressive press device.

The lower shoe 34 and the upper shoe 35, opposed to each other, are respectively provided on the bolster 31 and the slide 32. A stripper plate 36 connected to the upper shoe 35 via an elastic member is disposed below the upper shoe 35. The stripper plate 36 can move in the vertical direction relative to the upper shoe 35.

The progressive press device is provided, in order from upstream to downstream in the conveying direction of the material 33, with a first hole-punching section 37, a pressing section 38, a second hole-punching section 39, and a blanking section 40. Each of the first hole-punching section 37, the pressing section 38, the second hole-punching section 39, and the blanking section 40 is spaced apart from the adjacent section by a distance corresponding to the feed pitch of the material 33.

The first hole-punching section 37, the pressing section 38, and the second hole-punching section 39 are used to form center holes 20, tabs 16, mounting holes 15, and through-holes 19 in the material 33. The blanking section 40 is configured to blank the iron core pieces 12, the first separator plate 13, and the second separator plate 14 from the material 33. The progressive press device includes a control device 21 that controls each section, including the second hole-punching section 39 and the like.

### First Hole-Punching Section 37

The first hole-punching section 37 includes a die 41 and a punch 42 for forming the center hole 20 in the material 33. The die 41 is fixed to the lower shoe 34 of the bolster 31. The punch 42 is fixed to the upper shoe 35 of the slide 32. During a die-closing operation of the progressive press device, the punch 42 punches a portion of the material 33 corresponding to the center hole 20, thereby forming the center hole 20 in the material 33. After the center hole 20 is formed, during a die-opening operation of the progressive press device, the stripper plate 36 presses the material 33 toward the die 41 to release it from the punch 42. In addition, during the die-opening operation of the progressive press device, the material 33 is conveyed downstream by the predetermined feed pitch.

### Pressing Section 38

The pressing section 38 includes dies 43 and punches 44 for forming the tabs 16 in the material 33. The dies 43 are fixed to the lower shoe 34 of the bolster 31. The punches 44 are fixed to the upper shoe 35 of the slide 32. The punches 44 are positioned corresponding to the respective tabs 16 of the iron core piece 12 shown in FIG. 3. The die 43 and the punch 44 shown in FIG. 6 form a tab 16 in the material 33 by deforming the material 33 during the die-closing operation of the progressive press device. After the tabs 16 are formed, during the die-opening operation of the progressive press device, the stripper plate 36 presses the material 33 toward the die 41 to release it from the punches 44. In addition, during the die-opening operation of the progressive press device, the material 33 is conveyed downstream by the predetermined feed pitch.

### Second Hole-Punching Section 39

The second hole-punching section 39 includes dies 45 and punches 46 for forming the mounting holes 15 in the material 33, and dies 47 and punches 48 for forming the through-holes 19 in the material 33. The dies 45, 47 are fixed to the lower shoe 34 of the bolster 31. The punches 46 are fixed to the upper shoe 35 of the slide 32. During the die-closing operation of the progressive press device, the punches 46 punch portions of the material 33 corresponding to the mounting holes 15, thereby forming the mounting holes 15 in the material 33.

During the die-closing operation, the punches 48 punch portions of the material 33 corresponding to ones of the tabs 16, thereby forming the through-holes 19 in the material 33. The punches 48 are provided at positions corresponding to the respective tabs 16 in the material 33. The punches 48 are fixed to punching positions, at which the punches 48 can punch the material 33 during the die-closing operation, or are retracted into the upper shoe 35 so as not to punch the material 33 by being released from the fixed state during the die-closing operation. The fixing and releasing of the punches 48 are performed through control of a drive mechanism by the control device 21.

The control device 21 separately forms the tabs 16 of the iron core pieces 12, the tabs 16 and the through-holes 19 of the first separator plate 13, and the tabs 16 and the through-holes 19 of the second separator plate 14 by controlling the fixing and releasing of the punches 48 during the die-closing operation. Specifically, the fixing and releasing of the punches 48 during the die-closing operation are carried out in accordance with the following three patterns (A), (B), and (C).

In pattern (A), all of the punches 48 are released from fixation so that none of the punches 48 punch the material 33 during the die-closing operation. In this case, since the portions of the material 33 corresponding to the tabs 16 are not punched by the punches 48 during the die-closing operation, the tabs 16 remain in the material 33 as the tabs 16 of the iron core piece 12. The resulting arrangement of the tabs 16 corresponds to the arrangement of the tabs 16 in the iron core piece 12 as shown in FIG. 3.

In pattern (B), the punches 48 corresponding to the through-holes 19 of the first separator plate 13, as shown in FIG. 4, are fixed, and the other punches 48 are released from the fixed state. In this case, during the die-closing operation, the tabs 16 of the material 33 that are located at positions corresponding to the through-holes 19 of the first separator plate 13, along with its surrounding area, are punched by the punches 48, thereby forming the through-holes 19. Meanwhile, the tabs 16 of the material 33 corresponding to positions other than those of the through-holes 19 of the first separator plate 13 are not punched by the punches 48. Accordingly, these tabs 16 remain as the tabs 16 of the first separator plate 13. The arrangement of the tabs 16 and the through-holes 19 at this time is the same as the arrangement of the tabs 16 and the through-holes 19 of the first separator plate 13 shown in FIG. 4.

In pattern (C), the punches 48 corresponding to the through-holes 19 of the second separator plate 14, as shown in FIG. 5, are fixed, and the other punches 48 are released from the fixed state. In this case, during the die-closing operation, the tabs 16 of the material 33 that are located at positions corresponding to the through-holes 19 of the second separator plate 14, along with its surrounding area, are punched by the punches 48, thereby forming the through-holes 19. Meanwhile, the tabs 16 of the material 33 corresponding to positions other than those of the through-holes 19 of the second separator plate 14 are not punched by the punches 48. Accordingly, these tabs 16 remain as the tabs 16 of the second separator plate 14. The arrangement of the tabs 16 and the through-holes 19 at this time is the same as the arrangement of the tabs 16 and the through-holes 19 of the second separator plate 14 shown in FIG. 5.

The control device 21, during the repeated die-closing operation and die-opening operation of the progressive press device, repeatedly performs the fixing and releasing of the punches 48 in the order of one cycle of pattern (B), one cycle of pattern (C), and multiple cycles of pattern (A). As a result, the mounting holes 15 and the through-holes 19 are formed in the material 33. When the progressive press device performs the die-opening operation, the stripper plate 36 shown in FIG. 6 presses the material 33 toward the dies 45, 47 to separate it from the punches 46, 48. In addition, during the die-opening operation of the progressive press device, the material 33 is conveyed downstream by the predetermined feed pitch.

### Blanking Section 40

The blanking section 40 includes a die 49, a squeeze ring 50, and a punch 51 for punching and forming the iron core piece 12, the first separator plate 13, or the second separator plate 14 from the material 33. The die 49 is fixed to the lower shoe 34 of the bolster 31. The squeeze ring 50 is fixed to the lower side of the die 49 in the lower shoe 34. The punch 51 is fixed to the upper shoe 35 of the slide 32. During the die-closing operation of the progressive press device, the punch 46 punches portions of the material 33 corresponding to the mounting holes 15, thereby forming the iron core piece 12, the first separator plate 13, or the second separator plate 14.

When the fixing and releasing of the punches 48 in the second hole-punching section 39 are performed in accordance with the above-described patterns, the blanking section 40 forms the iron core piece 12, the first separator plate 13, and the second separator plate 14 as follows. Through punching of the material 33 by the punch 51 during each die-closing operation, the formation of one first separator plate 13, one second separator plate 14, and multiple iron core pieces 12 is repeatedly performed. During the die-opening operation of the progressive press device, the stripper plate 36 presses the material 33 toward the die 49 to release it from the punch 51.

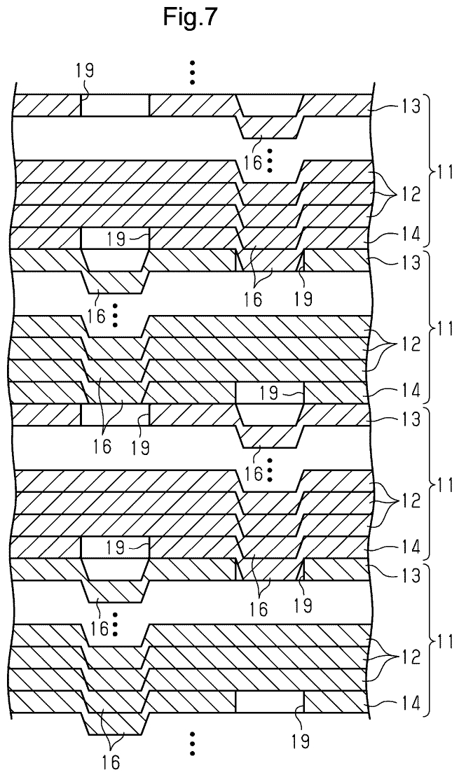

Additionally, the formed first separator plate 13, second separator plate 14, and iron core pieces 12 are stacked in the thickness direction inside the die 49 in each die-closing operation and are pressed downward toward the squeeze ring 50. At this time, as shown in FIG. 7, the tabs 16 of the first separator plate 13 overlap with the tabs 16 of the iron core piece 12 located below the first separator plate 13. Further, the through-holes 19 of the first separator plate 13 receive the tabs 16 of the second separator plate 14 located above the first separator plate 13. Additionally, the tabs 16 of the second separator plate 14 overlap with the tabs 16 of the iron core piece 12 located above the second separator plate 14. Furthermore, the tabs 16 of adjacent iron core pieces 12 also overlap with one another.

As described above, the first separator plate 13, the second separator plate 14, and the iron core pieces 12, which are stacked together, are pressed downward in each die-closing operation and thereby reach the interior of the squeeze ring 50. The inner diameter of the squeeze ring 50 is slightly smaller than the inner diameter of the die 49. As a result, when the first separator plate 13, the second separator plate 14, and the iron core pieces 12 reach the interior of the squeeze ring 50, their downward movement is restricted. Consequently, the first separator plate 13, the second separator plate 14, and the iron core pieces 12 are compressed in the thickness direction by the die-closing operation. This compression causes the overlapping tabs 16 of the first separator plate 13, the second separator plate 14, and the iron core pieces 12 to be press-fitted to each other.

By press-fitting the overlapping tabs 16 to each other, a block 11 is formed in which the iron core pieces 12 are interposed between the first separator plate 13 and the second separator plate 14. In this block 11, the second separator plate 14 is positioned in the lowermost layer, and the first separator plate 13 is positioned in the uppermost layer. Accordingly, in adjacent blocks 11, the second separator plate 14 of the upper block 11 is brought into contact with the first separator plate 13 of the lower block 11. Since the tabs 16 of the second separator plate 14 are inserted into the through-holes 19 of the first separator plate 13, the adjacent blocks 11 are not joined together at this stage by press-fitting the tabs 16 to each other.

The formed block 11 is pushed downward out of the squeeze ring 50 by the pressing force applied during each die-closing operation. The block 11 thus discharged is then conveyed by a conveyor 52 disposed below the squeeze ring 50 to be used in subsequent steps, in which a stator core is formed using blocks 11.

Next, a method for manufacturing a stator core as a motor core will be described.

In this manufacturing method, a block forming step for forming the block 11 by using the above-described progressive press device and a core forming step for forming a stator core by stacking and joining the multiple blocks 11 to each other are performed. Hereinafter, the block forming step and the core forming step will be individually described in detail.

### Block Forming Step

In this step, the block 11 is formed by punching the first separator plate 13, the second separator plate 14, and the multiple iron core pieces 12 from the material 33 and stacking them in the thickness direction so that the tabs 16 of the respective plates overlap with each other. In the block forming step, a first step and a second step are performed each time the iron core pieces 12 are stacked multiple times. In the first step, the first separator plate 13 is stacked on the iron core pieces 12. In the second process, the second separator plate 14 is stacked on the first separator plate 13. The first step and the second step are implemented by the blanking section 40 of the progressive press device. The first separator plate 13 formed in the first step and shown in FIG. 4 and the second separator plate 14 formed in the second step and shown in FIG. 5 are respectively disposed at the opposite ends in the stacking direction of the iron core pieces 12 in the block 11 formed through the first step and the second step.

If the first separator plate 13 formed in the first step and the second separator plate 14 formed in the second step are divided into multiple regions having the same angle around the center line L1, the positional relationship between the tabs 16 and the through-holes 19 is reversed in regions overlapping with each other in the thickness direction. As a result, when the first separator plate 13 is stacked onto the iron core pieces 12 in the first step, the tabs 16 of the first separator plate 13 are aligned with the tabs 16 of the iron core pieces 12. When the second separator plate 14 is stacked onto the first separator plate 13 in the second step, the tabs 16 of the second separator plate 14 are aligned with the through-holes 19 of the first separator plate 13. When additional iron core pieces 12 are stacked onto the second separator plate 14 after the second step, the tabs 16 of the iron core pieces 12 are aligned with the tabs 16 of the second separator plate 14.

Then, the first separator plate 13, the second separator plate 14, and the iron core pieces 12 are compressed in the thickness direction by the die-closing operation, so that the overlapping tabs 16 are press-fitted to each other. Through this press-fitting of the tabs 16, a block 11 is formed in which the iron core pieces 12 are interposed between the first and second separator plates 13 and 14. The blocks 11 formed by the blanking section 40 of the progressive press device such that adjacent ones are not joined. This is because the tabs 16 of the second separator plate 14 in the upper block 11 are inserted into the through-holes 19 of the first separator plate 13 in the lower block 11.

### Core Forming Step

In this step, the multiple blocks 11 are stacked while being rotated relative to each other such that the tabs 16 of the first separator plate 13 in a block 11 and the tabs 16 of the second separator plate 14 in another block 11 overlap with each other.

Specifically, a block 11 formed by the progressive press device is inverted top to bottom so that the first separator plate 13 is at the top. Thereafter, an additional block 11 is disposed on the inverted block 11. This additional block 11 is also inverted so that its first separator plate 13 is positioned at the top. Furthermore, the additional block 11 is rotated about the center line L1 such that the tabs 16 of its second separator plate 14 align with the tabs 16 of the underlying block 11. Such rotation of the additional block 11 is a rotation by an angle defining the region A1 to A3, i.e. by 120°.

FIG. 2 illustrates the state in which the blocks 11 are stacked in the direction in which the center line L1 extends by repeatedly stacking the blocks 11 while rotating the blocks 11 relative to each other as described above. The blocks 11 are stacked in the quantity necessary to form a stator core. The stacked blocks 11 are pressed in the direction in which the center line L1 extends by a pressing operation using a pressing device. As a result, the joining between the tabs 16 of the iron core pieces 12 in the block 11 through press-fitting is further strengthened. In addition, in any two blocks 11 adjacent to each other in the stacking direction, the tabs 16 of the second separator plate 14 in one block 11 are press-fitted to the tabs 16 of the first separator plate 13 in the other block 11, thereby joining the blocks 11 together. The stator core is thus formed by joining the multiple blocks 11 to one another.

Operation and advantages of the above-described method for manufacturing a stator core will now be described.

(1-1) Blocks 11 are formed in the block forming step, and the first separator plate 13 and the second separator plate 14 are disposed at the opposite ends of each block 11 in the stacking direction of the iron core pieces 12. At this time, the tabs 16 of the second separator plate 14 in one of two blocks 11 adjacent to each other in the stacking direction are inserted into the through-holes 19 of the first separator plate 13 in the other block 11. As a result, the adjacent blocks 11 are prevented from being joined together.

In the core forming step, multiple blocks 11 are stacked while being rotated relative to each other such that the tabs 16 of the first separator plate 13 in a block 11 and the tabs 16 of the second separator plate 14 in another block 11 overlap with each other. In a state in which the multiple blocks 11 are stacked in the direction in which the center line L1 of the iron core piece 12 extends, the multiple blocks 11 are pressed so as to be compressed in the direction in which the center line L1 extends. Specifically, the multiple blocks 11 are pressed so as to be compressed in the direction in which the center line L1 extends through the pressing process by the pressing device in order to further strengthen the joining by press-fitting the tabs 16 in the respective iron core pieces 12 of the multiple stacked blocks 11.

At this time, in any two blocks 11 adjacent to each other in the stacking direction of the blocks 11, the tabs 16 of the second separator plate 14 in one block 11 are press-fitted to the tabs 16 of the first separator plate 13 in the other block 11, thereby joining the blocks 11 together. The stator core is thus formed by joining the multiple blocks 11 to one another. When the stator core is formed in this manner, the multiple blocks 11 can be joined to each other without welding.

(1-2) If the second separator plate 14 and the first separator plate 13 of the block 11 formed in the block forming step are divided into multiple regions having the same angle around the center line L1, the positional relationship between the tabs 16 and the through-holes 19 is reversed in regions overlapping with each other in the thickness direction. In the core forming step, as the rotation of the block 11 after the block forming step, the block 11 is rotated around the center line L1 of the iron core piece 12 by the angle defining the above-described regions. Accordingly, the multiple blocks 11 are stacked such that the tabs 16 of the second separator plate 14 in one of the blocks 11 and the tabs 16 of the first separator plate 13 in an adjacent block 11 overlap with each other. Therefore, in the core forming step, when the multiple blocks 11 are stacked in the direction in which the center line L1 extends, the tabs 16 of the blocks 11 adjacent to each other are readily overlapped with each other as described above.

(1-3) The angle that defines the regions is 120°. The through-holes 19 of the first separator plate 13 are formed every 90° around the center line L1. In the first separator plate 13, two tabs 16 are formed between adjacent through-holes 19. The tabs 16 of the first separator plate 13 are located at equal intervals from each other and from the through-holes 19. The tabs 16 of the second separator plate 14 are formed every 90° around the center line L1. In the second separator plate 14, two through-holes 19 are formed between adjacent tabs 16. These through-holes 19 of the second separator plate 14 are located at equal intervals from each other and from the tabs 16. In the core forming step, as the rotation of the block 11 in the block forming step, the block 11 is rotated by 120° around the center line L1 of the iron core piece 12. Accordingly, the multiple blocks 11 are stacked such that the tabs 16 of the second separator plate 14 in the block 11 and the tabs 16 of the first separator plate 13 in the adjacent block 11 overlap with each other at four positions about the center line L1. The four positions correspond to four tabs 16 at equal angular intervals among the tabs 16 in FIG. 1. Since the multiple blocks 11 are joined to each other by the press-fitting the tabs 16 to each other at the four positions, the joining of the blocks 11 to each other is strengthened.

### Second Embodiment

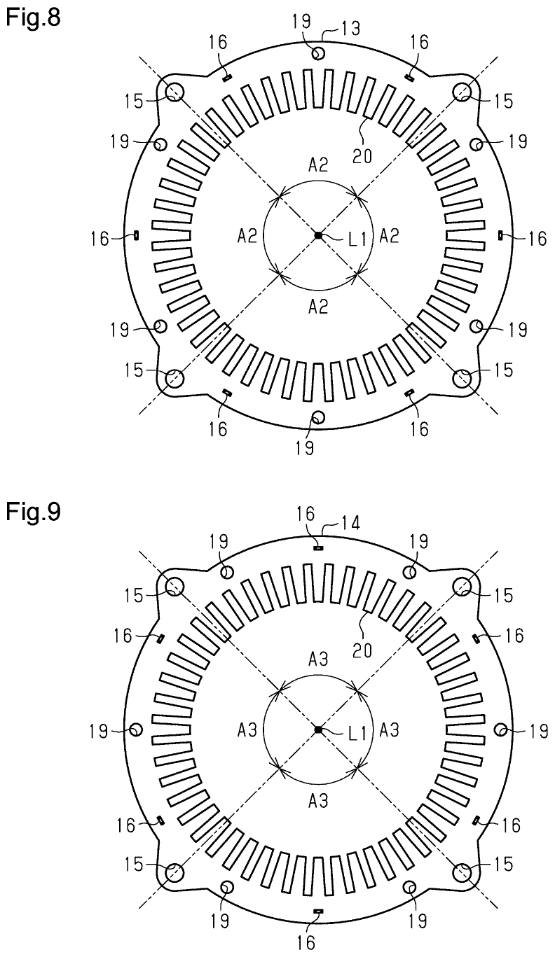

A method for manufacturing a motor core, such as a stator core, according to a second embodiment will now be described with reference to FIGS. 8 to 11.

The second embodiment is different from the first embodiment in that when the first separator plate 13 and the second separator plate 14 are each divided into multiple regions having the same angle around the center line L1, the number of regions is an even number, and the angle is 90°. Specifically, by setting the angle to 90°, the multiple regions are four regions.

As shown in FIG. 8, the first separator plate 13 includes four regions A2. Four mounting holes 15 are formed in the first separator plate 13 at equal angular intervals around the center line L1, specifically at intervals of 90°. The total number of the tabs 16 and the through-holes 19 of the first separator plate 13 in each region A2 is an odd number, and the tabs 16 and the through-holes 19 are alternately formed at equal angular intervals around the center line L1. In this example, the total number of the tabs 16 and the through-holes 19 within each region A2 is three. Therefore, the first separator plate 13 includes six tabs 16 and six through-holes 19 as a whole.

As shown in FIG. 9, the second separator plate 14 includes four regions A3. Four mounting holes 15 are formed in the second separator plate 14 at equal angular intervals around the center line L1, specifically at intervals of 90°. The total number of the tabs 16 and the through-holes 19 of the second separator plate 14 in each region A3 is an odd number as in the first separator plate 13, and the tabs 16 and the through-holes 19 are alternately formed at equal angular intervals around the center line L1. In this example, the total number of the tabs 16 and the through-holes 19 within each region A3 is three. Therefore, the second separator plate 14 includes six tabs 16 and six through-holes 19 as a whole.

Each iron core piece 12 also includes four regions A1. The tabs 16 of the iron core piece 12 are formed at equal angular intervals around the center line L1. The number of the tabs 16 in each iron core piece 12 is twelve. Each iron core piece 12 also includes four mounting holes 15 formed at equal angular intervals around the center line L1, specifically at angular intervals of 90°.

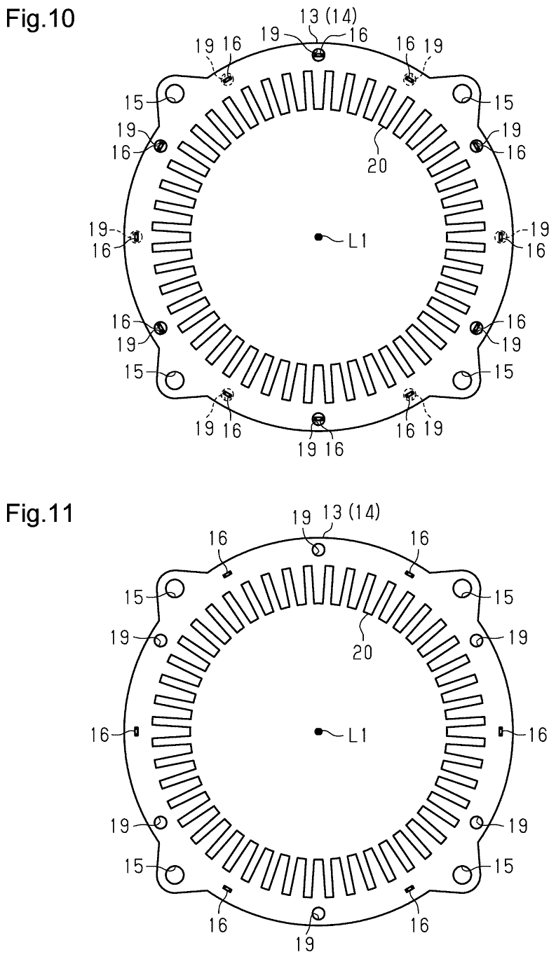

FIG. 10 shows a positional relationship around the center line L1 between the first separator plate 13 and the second separator plate 14 formed in the block forming step. FIG. 11 shows a positional relationship between the first separator plate 13 and the second separator plate 14 that are in contact with each other in adjacent blocks 11 when the stator core is formed in the core forming step.

The present embodiment has the following advantage in addition to advantages (1-1) and (1-2) of the first embodiment.

(2-1) The first separator plate 13, which is punched from the material 33 in the first step of the block forming step, and the second separator plate 14, which is punched from the material 33 in the second step, have the same shape including the tabs 16 and the through-holes 19. However, the first separator plate 13 and the second separator plate 14, which are punched from the material 33 in the block forming process, are positioned to be shifted by an angle that defines the regions A2, A3 in the rotation direction around the center line L1 of the iron core piece 12. Accordingly, in the core forming step, as the rotation of the block 11 after the block forming step, the rotation around the center line L1 of the iron core piece 12 by 90° is performed. Accordingly, the multiple blocks 11 are stacked such that the tabs 16 of the second separator plate 14 in one of the blocks 11 and the tabs 16 of the first separator plate 13 in an adjacent block 11 overlap with each other. The multiple blocks 11 are thus joined to each other by press-fitting the tabs 16 to each other.

### Other Embodiments

The above described embodiments may be modified as follows. The above-described embodiments and the following modifications can be combined as long as the combined modifications remain technically consistent with each other.

In the second embodiment, the numbers of the tabs 16 and the through-holes 19 in the first separator plate 13 and the second separator plate 14 may be changed.

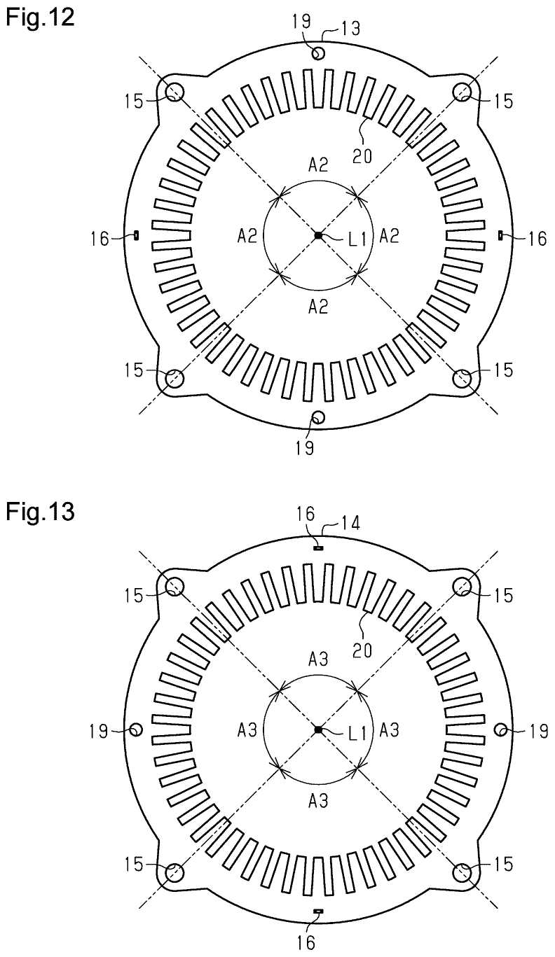

For example, as shown in FIGS. 12 and 13, the number of the tabs 16 and the number of the through-holes 19 in the first separator plate 13 may be two, and the number of the tabs 16 and the number of the through-holes 19 in the second separator plate 14 may be two.

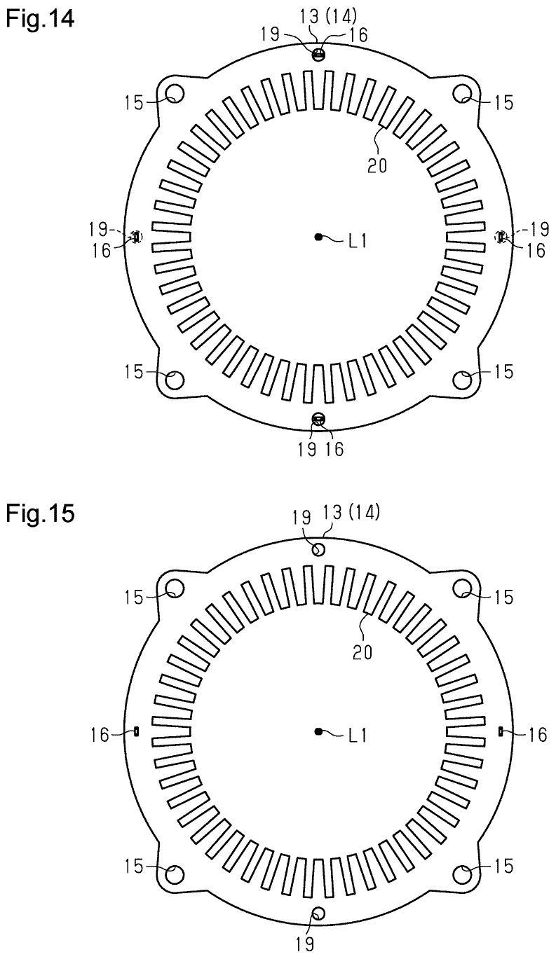

In this case, the positional relationship around the center line L1 between the first separator plate 13 and the second separator plate 14 formed in the block forming step is as shown in FIG. 14. FIG. 15 shows a positional relationship between the first separator plate 13 and the second separator plate 14 that are in contact with each other in adjacent blocks 11 when the stator core is formed in the core forming step.

Instead of a stator core, a rotor core can be manufacture as a motor core.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for manufacturing a motor core, comprising:
forming multiple blocks by punching iron core pieces each having a tab from a thin plate-shaped material and stacking the iron core pieces such that the tabs overlap with each other; and
forming the motor core by stacking the blocks and joining the blocks to each other, wherein
the forming the blocks includes, every time the iron core pieces are stacked multiple times, arranging a first separator plate and a second separator plate at opposite ends in a stacking direction of the iron core pieces of each block by
punching the first separator plate having a tab and a through-hole from the material and stacking the first separator plate on the iron core pieces, and
punching the second separator plate having a tab and a through-hole from the material and stacking the second separator plate on the first separator plate,
when the first separator plate is stacked on the iron core pieces, the tab of the first separator plate is aligned with the tabs of the iron core pieces,
when the second separator plate is stacked on the first separator plate, the tab of the second separator plate is aligned with the through-hole of the first separator plate,
when the iron core pieces are stacked on the second separator plate after the second separator plate is stacked on the first separator plate, the tabs of the iron core pieces are aligned with the tab of the second separator plate, and
the forming the motor core includes:
stacking the blocks while rotating the blocks relative to each other such that the tab of the first separator plate of one of any two blocks adjacent to each other in the stacking direction of the blocks and the tab of the second separator plate of the other of the two blocks overlap with each other; and
in this state, joining the blocks together by press-fitting the tabs to each other.

2. The method for manufacturing a motor core according to claim 1, wherein
the tab and the through-hole of the first separator plate are one of multiple tabs and one of multiple through holes, the tabs and the through-holes being formed at equal angular intervals around a center line of the block,
the tab and the through-hole of the second separator plate are one of multiple tabs and one of multiple through holes, the tabs and the through-holes being formed at equal angular intervals around the center line of the block,
in the forming the multiple blocks, if the first separator plate stacked on the iron core pieces and the second separator core stacked on the first separator core are each divided into multiple regions having equal angles around the center line, a positional relationship between the tabs and the through-holes is reversed in overlapping regions in a thickness direction, and
in the forming the motor core, the blocks are rotated around the center line by an angle defining each region as rotation of the blocks after the forming of the blocks, and
through the rotation, each tab of the first separator plate of one of the two adjacent blocks and one of the tabs of the second separator plate of the other of the two adjacent blocks overlap with each other.

3. The method for manufacturing a motor core according to claim 2, wherein the regions are an odd number of regions having equal angles around the center line.

4. The method for manufacturing a motor core according to claim 3, wherein
the angle defining each region is 120°,
the through-holes of the first separator plate are formed at intervals of 90° around the center line,
the tabs of the first separator plate include two tabs that are formed between adjacent two of the through-holes and are located at equal intervals from each other and from the through-holes,
the tabs of the second separator plate are formed at intervals of 90° around the center line, and
the through-holes of the second separator plate include two through-holes that are formed between adjacent two of the tabs and are located at equal intervals from each other and from the tabs.

5. The method for manufacturing a motor core according to claim 2, wherein the regions are an even number of regions having equal angles around the center line.

6. The method for manufacturing a motor core according to claim 5, wherein
the angle defining each region is 90°,
a total number of the tabs and the through-holes of the first separator plate in each region is an odd number, and the tabs and the through-holes are alternately formed at equal angular intervals around the center line, and
a total number of the tabs and the through-holes of the second separator plate in each region is the same odd number as that of the first separator plate, and the tabs and the through-holes are alternately formed at equal angular intervals around the center line.
